(19) United States
(12) Patent Application Publication
(10) Pub. No.: US 2004/0078539 A1
(43) Pub. Date: Apr. 22, 2004

(54) De-fragmenting memory by re-booting based on time

(76) Inventor: Patrick W. Fulghum, Boise, ID (US)

Correspondence Address: HEWLETT-PACKARD COMPANY, Intellectual Property Administration, P. O. Box 272400, Fort Collins, CO, 80527-2400, US

(21) Appl. No.: 10/273,831

(22) Filed: Oct. 18, 2002

(51) Int. Cl. G06F 12/00

(52) U.S. Cl. 711/170; 713/2

(57) ABSTRACT

A de-fragmentation processor of a system determines whether to re-boot the system based on a time at which the system is scheduled to be in a ready state. As a scheduled time at which the system is to be in a ready state approaches, the de-fragmentation processor causes the system to re-boot.

### RELATED APPLICATION

This application is related to the following U.S. patent application, the disclosure of which is incorporated by reference herein:

application Ser. No.______, bearing Attorney Docket No. 10018173-1, filed ______, entitled “De-Fragmenting Memory by Re-Booting Based on Usage”, and naming Patrick W. Fulghum as inventor.

### TECHNICAL FIELD

This invention relates to methods and systems for de-fragmenting memory.

### BACKGROUND

Many electronic devices are implemented as embedded systems with limited, consumable memory resources. One example of such a device is a printer, which may be connected to one or more computers, either directly or via a network. The performance of embedded systems with limited memory resources is negatively impacted if the available memory becomes fragmented. Memory fragmentation commonly occurs, for example in a printer, when electronic documents of varying sizes are processed (i.e., printed) by the device.

Such devices typically have a system application that controls the functionality of the device. The system application is stored in memory, and therefore impacts the amount of memory available. For example, the smaller the amount of memory necessary to store the system application, the more memory will be available for supporting the device functionality.

Some system applications include complex de-fragmentation algorithms that can be executed to de-fragment memory, which increases the performance of the device. One problem with de-fragmentation algorithms implemented as part of a system application is that more memory is needed to store the system application (because of the complex de-fragmentation algorithm), and therefore less memory is available to support device functionality.

### SUMMARY

A method for de-fragmenting memory by automatically re-booting a system based on time is described. At some time prior to a time at which the system is in a ready state, the system is re-booted.

### BRIEF DESCRIPTION OF THE DRAWINGS

The same numbers are used throughout the drawings to reference like features and components.

FIG. 1 is a block diagram that illustrates various components of a network environment that includes an exemplary printing device.

FIG. 2 is a flow diagram that describes a method for de-fragmenting memory in an exemplary printing device.

### DETAILED DESCRIPTION

Introduction

The following describes de-fragmenting and reclaiming memory in an embedded system. The following method for de-fragmenting and reclaiming memory will be described with reference to a networked printer, but it is recognized that the described method may be implemented in any number of embedded systems with limited memory resources. Essentially all computer-based systems have limited memory that must be managed. Examples of other types of systems in which the described method may be implemented include telephone switching systems, personal computers, television set-top boxes, scanners, faxes, and other types of office equipment.

When a document is sent to a printer to be printed, the document, or some representation of the document, is typically stored in the printer's memory prior to printing. The document is typically deleted from the printer's memory after the document is successfully printed. Over time, as a printer receives, stores, prints, and deletes documents of various sizes, it is common for the printer's memory to become fragmented. Fragmented memory results in decreased printer performance.

When a printer is re-booted, the memory is wiped clean, and as a result, the printer's memory is no longer fragmented. However, it may take several minutes to re-boot a printer, and having the printer unavailable for several minutes may be unacceptable in an office environment in which the printer is heavily used. As such, it is important to determine an appropriate time to re-boot the printer that will result in de-fragmentation of the printer's memory and minimum usage impact.

Exemplary Memory De-fragmentation Environment

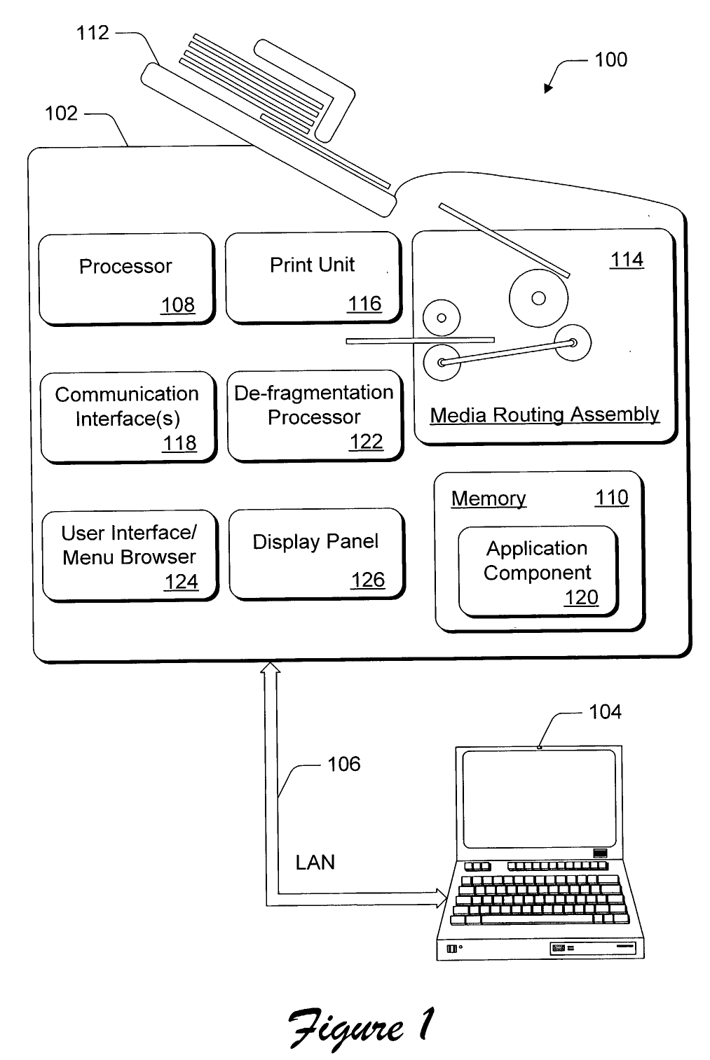

FIG. 1 illustrates components of a network environment 100 in which memory in a printing device 102 can be de-fragmented. Printing device 102 is connected with a computing system 104 via a data communication network 106.

Computing system 104 can be any type of computing system capable of communicating with printing device 102. The data communication network 106 can be any type of network, such as a local area network (LAN) or a wide area network (WAN), using any type of network topology and any network communication protocol. Although only a few devices are shown communicatively linked via network 106, a typical network can have any number of devices connected to it, either directly or indirectly via another network system. The Internet is an example of multiple connected network systems each having multiple devices. Printing device 102 and the computing system 104 can also have modems and/or network cards that facilitate network communication and data transfer via data communication network 106. Alternatively, printing device 102 and computing system 104 may be connected directly via a parallel, serial, USB, wireless, or other such connection.

Printing device 102 includes one or more processors 108, a memory component 110, a media tray 112, a media routing assembly 114, a print unit 116, and one or more communication interfaces 118. Additionally, although not shown, a system bus typically connects the various components within printing device 102.

Printing device 102 also includes an application component 120 that is implemented as a permanent memory module stored in memory component 110, or implemented with other components in printing device 102. For example, an application component can be implemented as a component of processor 108, or as a component of a printer controller. Application component 120 is programmed and tested like software, and is distributed with printing device 102. Application component 120 can be implemented to coordinate operations of the hardware within printing device 102 and contains programming constructs used to perform such operations.

Processor(s) 108 process various instructions to control the operation of printing device 102 and to communicate with other electronic and computing devices.

Memory component 110 stores various information and/or data such as configuration information, fonts, templates, print data, and menu structure information.

Media tray 112 holds physical print media, such as paper, plastic, fabric, Mylar, transparencies, and the like. The print media is fed from the media tray 112 to the media routing assembly 114, which sends the print media to the print unit 116 where an image is printed onto the print media.

Communication interface(s) 118 provide a connection between printing device 102 and one or more computing devices 104 or data communication networks 106. Communication interfaces 118 may include, for example, one or more of a parallel, serial, USB, wireless, or network interface. Implemented as a network interface, communication interface 118 allows devices coupled to a common data communication network to send print jobs, menu data, and other information to printing device 102 via the network 106. Similarly, implemented as a parallel, serial, or USB interface, communication interface 118 provides a data communication path directly between printing device 102 and another electronic or computing device.

Printing device 102 also includes a de-fragmentation processor 122, which may be implemented as part of application component 120, or as a separate component stored in memory, or implemented with other components in printing device 102. De-fragmentation processor 122 controls memory de-fragmentation by determining an appropriate time to re-boot the system, resulting in memory de-fragmentation.

Printing device 102 may also include a user interface and menu browser 124, and a display panel 126. The user interface and menu browser 124 allows a user of printing device 102 to navigate the device's menu structure. User interface 124 can include indicators and/or a series of buttons, switches, or other selectable controls that are manipulated by a user of the printing device. Display panel 126 is a graphical display that provides information regarding the status of printing device 102 and the current options available to a user through the menu structure. One parameter that may be set by a user through the user interface is a particular time at which the user wants the printer to be in a ready state.

Methods for De-fragmenting Memory by Re-booting Based on Time

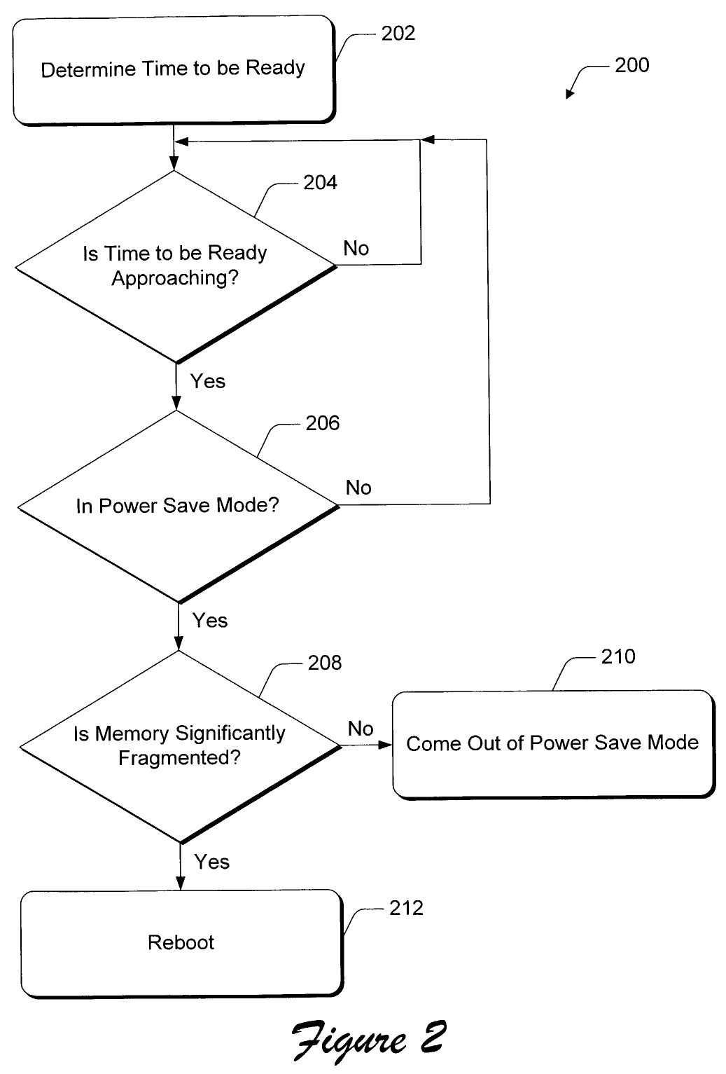

FIG. 2 illustrates a method 200 for de-fragmenting memory by re-booting a system. The order in which the method is described is not intended to be construed as a limitation. Furthermore, the method can be implemented in any suitable hardware, software, firmware, or combination thereof. In one embodiment, the method can be implemented by the system illustrated in FIG. 1.

A system may have several possible states, such as “off”, “ready”, and “power save”. When a system is in the off state, the system consumes little or no energy, and no system functionality is available. When a system is in the ready state, typically all system functionality is available. When a system is in the power save state, the system typically consumes less energy than when in the ready state, and may need to go through a short warm up process to return to the ready state.

At block 202, a de-fragmentation processor determines a time at which the system is to be in a ready state. In one implementation, the specific time of day for the system to be in the ready state may be set by a user through a user interface associated with the system. For example, in an office setting, a printer may be scheduled to be in a ready state every weekday morning at 8:00 am.

At block 204, the de-fragmentation processor determines whether the specified time to be in the ready state is approaching. For example, the de-fragmentation processor may determine that the specified time is approaching when five minutes (or some other set amount of time) is remaining before the specified time. The amount of lead time prior to the specified ready time may be determined based on the amount of time required to re-boot the system. For example, if it takes two minutes for a printer to re-boot, and the printer is scheduled to be ready at 8:00 am, then at 7:58 am the system may determine that the scheduled time to be ready is approaching.

At block 206, if the ready state time is approaching, the de-fragmentation processor determines whether the system is in a power save mode. Typically, a printing device will automatically enter a power save mode if there has been no communication from a computing system for a set period of time, for example, two hours. For instance, in an office setting with normal operating hours of 8:00 am-5:00 pm, the printer may typically be in a power save mode between the hours of 7:00 pm and 8:00 am. If the system is not in a power save mode, the method returns to block 204. If the system is in a power save mode, the method continues to block 208.

At block 208, when the de-fragmentation processor determines that the system is in power save mode and that the specified time to be ready is approaching, the de-fragmentation processor then examines the memory to determine whether the memory is significantly fragmented. The degree of memory fragmentation that is considered significant may vary depending on the system. For example, in systems with small amounts of memory the system performance may decline when 25% of the memory is fragmented. Alternatively, performance of a system with a large amount of memory may not decline until the memory is 60% fragmented. In one implementation, the degree of memory fragmentation that is considered significant may be configurable by a user, for example, through a user interface associated with the system.

If the memory is not significantly fragmented (the “no” branch from block 208), then in block 210, the de-fragmentation processor causes the system to come out of the power save mode and into the ready mode.

If the memory is significantly fragmented (the “yes” branch from block 208), then in block 212, the de-fragmentation processor causes the system to re-boot. After the re-boot, the memory is no longer fragmented and the system is in a ready state.

In an alternate implementation, the system may not examine the memory to determine the degree to which it is fragmented, but may just initiate a system re-boot based on the schedule time to be ready and the determination that the system is in a power save mode.

Conclusion

Re-booting a system (e.g., a printer) just prior to a time when the system is scheduled to be ready facilitates de-fragmentation of the system memory without negatively impacting the system users.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for de-fragmenting system memory of a system, comprising:
determining a time for the system to be ready;
prior to the determined time to be ready, determining whether the system is in a power save mode;
responsive to determining that the system is in a power save mode, determining whether the system memory is fragmented; and
responsive to determining that the system memory is fragmented, de-fragmenting the system memory.

2. The method as recited in claim 1, wherein the de-fragmenting is performed by causing the system to reboot.

3. The method as recited in claim 1, wherein the determining and de-fragmenting are performed by a printer.

4. A method comprising:
anticipating a time for a printer to be ready to print;
determining whether memory in the printer is fragmented; and
causing the printer to reboot before the time for the printer to be ready to print to de-fragment the printer memory.

5. The method as recited in claim 4, further comprising determining whether the printer is in a power save mode; and wherein the causing the printer to reboot occurs in response to determining that the printer is in the power save mode.

6. A method, comprising:
receiving an indication of a ready time when a system is to be in a ready state; and
at a time prior to the ready time, rebooting the system, such that the system is in a ready state at the ready time.

7. A method as recited in claim 6, wherein the time prior to the ready time is based on the amount of time needed to reboot the system.

8. A method as recited in claim 6, further comprising prior to rebooting the system, determining whether the system is in a power save mode; and wherein the rebooting the system occurs in response to determining that the system is in the power save mode.

9. A method as recited in claim 6, further comprising:
prior to rebooting the system, determining whether system memory is fragmented; and wherein the rebooting the system occurs in response to determining that the system memory is fragmented.

10. A method, comprising:
ascertaining a ready time when a printer is to be in a ready state; and
at a time prior to the ready time, rebooting the printer to de-fragment memory in the printer, such that the printer is in a ready state at the ready time.

11. A method as recited in claim 10, wherein the time prior to the ready time is based on the amount of time needed to reboot the printer.

12. A method as recited in claim 10, further comprising prior to rebooting the printer, determining whether the printer is in a power save mode; and wherein the rebooting the printer occurs in response to determining that the printer is in the power save mode.

13. A method as recited in claim 10, further comprising:
prior to rebooting the printer, determining whether printer memory is fragmented; and wherein the rebooting the printer occurs in response to determining that the printer memory is fragmented.

14. A system comprising:
memory; and
a system application configured to reboot the system when the system is in a power save mode, such that the memory is not fragmented and the system is in a ready mode at a scheduled time for the system to be ready.

15. A system as recited in claim 14, implemented as a printer.

16. A system as recited in claim 14, implemented as a networked printer.

17. A system comprising:
memory; and
a de-fragmentation processor configured to reboot the system when the system is in a power save mode and the memory is fragmented, such that the memory is de-fragmented and the system is in a ready mode at a scheduled time for the system to be ready.

18. A system as recited in claim 17, implemented as a printer.

19. A system as recited in claim 17, implemented as a networked printer.

20. One or more computer-readable media comprising computer executable instructions that, when executed, direct a computing system to:
determine that a scheduled time for the computing system to be in a ready state is approaching;
determine that the computing system is in a power save mode;
determine that at least a portion of memory associated with the computing system is fragmented; and
reboot the computing system such that the memory is de-fragmented and the computing system is in a ready state at the scheduled time.

21. One or more computer-readable media comprising computer executable instructions that, when executed, direct a printer to:
determine that a scheduled time for the printer to be ready to print is approaching;
determine that the printer is in a power save mode;
determine that at least a portion of a memory resource associated with the printer is fragmented; and
reboot the printer such that the memory resource is de-fragmented and the printer is ready to print at the scheduled time.

22. One or more computer-readable media comprising computer executable instructions that, when executed, direct a computing system to:
determine a ready time when the system is to be in a ready state; and
reboot the system, such that the system is in the ready state at the ready time.

23. The one or more computer-readable media as recited in claim 22 further comprising computer executable instructions that, when executed, direct the computing system to:
determine a reboot time equal to an amount of time required to reboot the system; and
initiate the reboot at a time prior to the ready time such that the time prior is equal to or greater than the reboot time.

24. The one or more computer-readable media as recited in claim 22 further comprising computer executable instructions that, when executed, direct the computing system to:
determine whether the system is in a power save mode; and
reboot the system in response to determining that the system is in the power save mode.

25. The one or more computer-readable media as recited in claim 22 further comprising computer executable instructions that, when executed, direct the computing system to:
determine whether memory associated with the system is fragmented; and
reboot the system in response to determining that the memory is fragmented.

26. A system comprising:
memory;
means for determining whether the memory is fragmented; and
means for re-booting the system to de-fragment the memory.

27. The system as recited in claim 26, further comprising means for determining whether the system is in a power save mode.

28. A printer comprising:
memory;
means for ascertaining a ready time at which the printer is to be ready to print; and
means for re-booting the printer, such that the printer is ready to print at the ready time.

29. A printer as recited in claim 28, further comprising:
means for determining whether memory associated with the printer is fragmented.
